(19) United States
(12) Patent Application Publication
(10) Pub. No.: US 2011/0318447 A1
(43) Pub. Date: Dec. 29, 2011

(54) Angled Core-Pulling Mechanism of Mold

(75) Inventors: Xiaoping Wu, Taipei (TW); Shih-Hsiung Ho, Taipei (TW)

(73) Assignee: CHENG UEI PRECISION INDUSTRY CO., LTD., Taipei (TW)

(21) Appl. No.: 12/824,603

(22) Filed: Jun. 28, 2010

(51) Int. Cl. B29C 33/12

(52) U.S. Cl. 425/468

(57) ABSTRACT

An angled core-pulling mechanism of mold includes a core insert, a shaping core and a slide block of which a rear end longitudinally defines a slide passage having a bottom side slanted downward from front to rear. The core insert defines a shaping cavity, a slide hole extending downward and slanting forward with a top communicating with the shaping cavity, and a receiving fillister having a level bottom face and with a top being connected with a bottom of the slide hole. One end of the shaping core is slantwise slidably disposed in the slide passage, and the other end is slantwise slidably disposed in the slide hole. The slide block can longitudinally move along the bottom face to drive the shaping core to slide slantwise upward and downward along the slide hole so that the shaping core can be inserted into or withdrawn out of the shaping cavity.

### BACKGROUND OF THE INVENTION

1. Field of the Invention

The present invention generally relates to a mold mechanism, and more particularly to an angled core-pulling mechanism of mold.

2. The Related Art

A conventional angled core-pulling mechanism of mold includes a cylinder system and a mechanical system. The cylinder system supplies the power energy to the angled core-pulling mechanism of mold by a reciprocal motion of a piston in the cylinder. The core-pulling process is accomplished by the cylinder system and the mechanical system working together. The cylinder system of the conventional angled core-pulling mechanism of mold includes a cylinder base, a fixing part, a hydraulic control valve, a stroke control device and so on. As a result, the angled core-pulling mechanism of mold has a complicated structure that results in a difficult assembly. Moreover, it costs too much for producing such an angled core-pulling mechanism of mold and is difficult to mold holes in a small plastic product. To overcome the above shortcomings, the present invention tends to provide an improved angled core-pulling mechanism of mold with a simple structure, a smaller size and easily being assembled.

### SUMMARY OF THE INVENTION

An object of the present invention is to provide an angled core-pulling mechanism of mold which includes a core insert and a core-pulling body movably mounted to the core insert. The core insert defines a shaping cavity, a slide hole at one side of the shaping cavity, and a receiving fillister opened in a front of the core insert and having a level bottom face. The slide hole extends downward and slants forward. A top of the slide hole communicates with the shaping cavity and a bottom of the slide hole is connected with a top of the receiving fillister. The core-pulling body includes a shaping core and a slide block. The shaping core has a base block of which two opposite end surfaces oppositely protrude to form a track and a shaping portion. The base block is slantwise slidably disposed in the slide hole of the core insert. The slide block has a base body of which a rear end longitudinally defines a slide passage penetrating through a top surface and a rear surface. A bottom side of the slide passage slants downward from a front to a rear thereof. The track of the shaping core is slidably disposed in the slide passage. The slide block can longitudinally move along the bottom face of the receiving fillister to drive the shaping core to slide slantwise upward and downward along the slide hole so that the shaping portion of the shaping core can be inserted into or withdrawn out of the shaping cavity.

As described above, the angled core-pulling mechanism of mold can realize the angled core-pulling process by the cooperation between the slide block and the shaping core. Comparing to the conventional angled core-pulling mechanism of mold, the angled core-pulling mechanism of mold of the present invention does not need extra apparatus providing a driving force to realize the angled core-pulling process. Therefore, the angled core-pulling mechanism of mold has a so simple structure that it has a smaller size to mold holes of a small plastic product and can be easily assembled.

### BRIEF DESCRIPTION OF THE DRAWINGS

The present invention will be apparent to those skilled in the art by reading the following description, with reference to the attached drawings, in which:

FIG. 1 is an assembly perspective view of an angled core-pulling mechanism of mold in accordance with the present invention;

FIG. 2 is an exploded perspective view of the angled core-pulling mechanism of mold of FIG. 1;

FIG. 3 is a perspective view of a slide block of the angled core-pulling mechanism of mold of FIG. 1; and

FIGS. 4-6 are cross-sectional views of the angled core-pulling mechanism of mold, showing a core-pulling process between a core-pulling body and a core insert.

### DETAILED DESCRIPTION OF THE PREFERRED EMBODIMENT

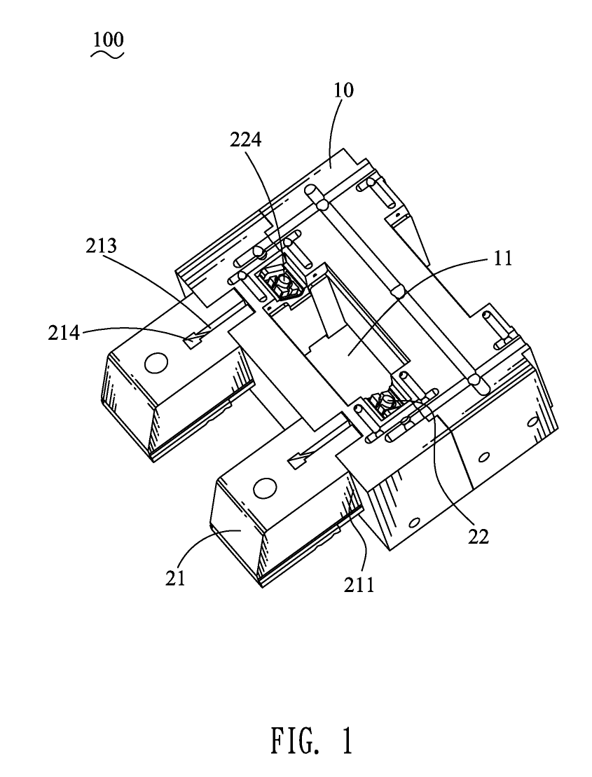

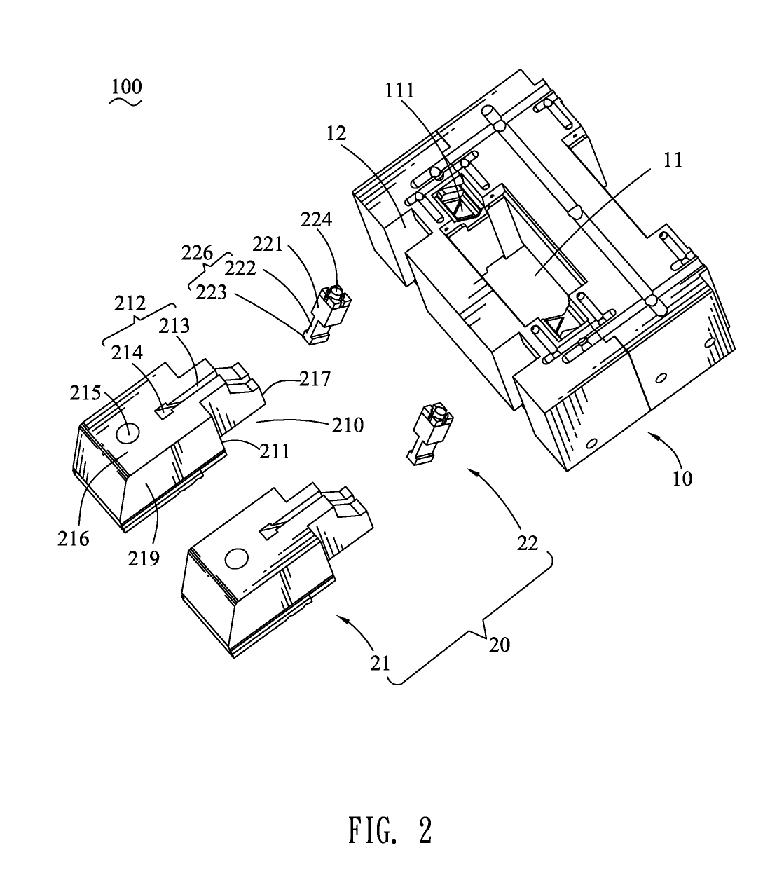

With reference to FIG. 1 and FIG. 2, an angled core-pulling mechanism of mold 100 according to the present invention is adapted to mold a plastic product with holes which show an angle between the extending direction thereof and a withdrawn direction of the plastic product being out of the mold 100. The angled core-pulling mechanism of mold 100 includes a core insert 10 and a core-pulling body 20.

Referring to FIG. 2, FIG. 5 and FIG. 6, the core insert 10 is of substantially rectangular shape and defines a shaping cavity 11 vertically penetrating through a substantial middle thereof. The core insert 10 further defines a pair of slide holes 111 located at two opposite sides of the shaping cavity 11. Each of the slide holes 111 extends downward and slants forward. A top of the slide hole 111 communicates with the shaping cavity 11. A pair of openings 12 is opened in a front of the core insert 10 and spaced from each other to be respectively located in alignment with the slide holes 111. A substantial middle of the opening 12 further extends reward to form a receiving fillister 13 having a level bottom face 131. A top of the receiving fillister 13 is connected with a bottom of the corresponding slide hole 111. A rear side of the opening 12 connected with the bottom face 131 of the receiving fillister 13 is acted as a guiding slope 14 slanting forward from a top to a bottom thereof. The guiding slope 14 lies in the same plane with a lower face of the corresponding slide hole 111.

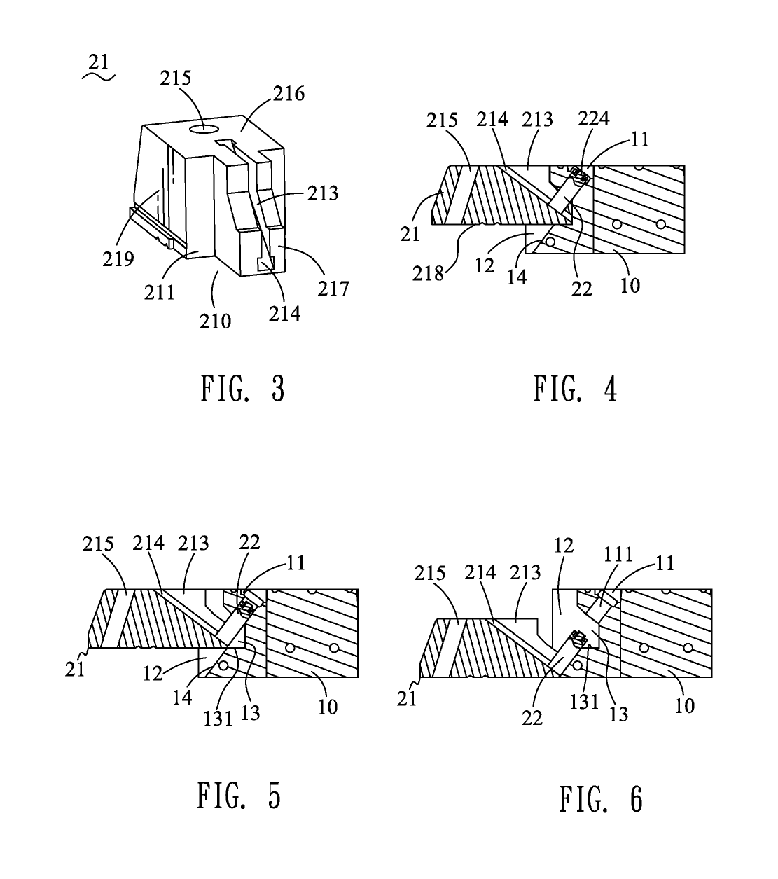

Referring to FIG. 2, FIG. 3 and FIG. 4, the core-pulling body 20 includes two slide blocks 21 and two shaping cores 22 slantwise slidably mounted to the slide blocks 21 respectively. The slide block 21 has a substantially rectangular base body 219 of which two opposite corners of a rear end are cut away to form a pair of rectangular gaps 210. Accordingly, a blocking wall 211 is formed in a front of each of the gaps 210. A middle of the rear end of the base body 219 longitudinally defines a slide passage 212 penetrating through a top surface 216 and a rear surface 217, and having a bottom side gradually slanted downward from a front to a rear thereof. The bottom side of the slide passage 212 is directly connected with the top surface 216 by the front thereof. The slide passage 212 includes a slide slot 213 and a slide channel 214 connected with a bottom of the slide slot 213 and having a greater width than the one of the slide slot 213. A front of the base body 219 defines a columned perforation 215 penetrating through the top surface 216 and a bottom surface 218, and slanting forward from a top to a bottom thereof for receiving a guide pin (not shown) therein. The shaping core 22 has a base block 221 corresponding to the slide hole 111 of the core insert 10. A middle of one end surface of the base block 221 perpendicularly protrudes to form a substantially T-shaped track 226. The track 226 includes a restraining portion 223 corresponding to the slide channel 214 of the slide block 21, and a connecting plate 222 corresponding to the slide slot 213 and connected between the base block 221 and a middle of the restraining portion 223. A middle of the other end surface of the base block 221 protrudes towards an opposite direction to the track 226 to form a shaping portion 224.

Referring to FIGS. 1-6, in assembly, the track 226 of the shaping core 22 is slantwise slidably disposed in the slide passage 212 of the corresponding slide block 21, wherein the restraining portion 223 is slidably disposed in the slide channel 214 and the connecting plate 222 is received in the slide slot 213. The base block 221 projects beyond the slide block 21. Then the core-pulling body 20 is assembled to the core insert 10. The rear end of the slide block 21 is disposed in the corresponding opening 12 of the core insert 10 with a bottom of the rear surface 217 of the slide block 21 being against the guiding slope 14 and the shaping core 22 being also against the guiding slope 14. The slide block 21 is pushed slantwise upward to move along the guiding slope 14 so as to make the base block 221 of the shaping core 22 inserted into the corresponding slide hole 111. Then the slide block 21 is pushed rearward along the bottom face 131 to make the rear end thereof received in the receiving fillister 13. At this moment, the blocking walls 211 abut against a front surface of the core insert 10. In the process of the slide block 21 moving rearward along the bottom face 131, the track 226 slides slantwise upward along the slide passage 212 to make the shaping portion 224 stretch out of the slide hole 111 and inserted into the shaping cavity 11 for molding the corresponding hole of the plastic product.

When the plastic product molded in the shaping cavity 11 of the core insert 10 is withdrawn out of the shaping cavity 11, the guide pin inserted in the perforation 215 moves upward to drive the slide block 21 to move forward along the bottom face 131, and further drive the track 226 to slide slantwise downward along the slide passage 212 so as to make the shaping portion 224 separate from the plastic product. So the corresponding hole is formed in the plastic product. After the rear end of the slide block 21 moves out of the receiving fillister 13, the slide block 21 further slides forward and downward along the guiding slope 14 so as to drive the shaping core 22 to move forward and downward along the slide hole 111 until the base block 221 and the shaping portion 224 come off the slide hole 111. At this time, the core-pulling body 20 is separated from the core insert 10.

As described above, the angled core-pulling mechanism of mold 100 can realize the angled core-pulling process by the cooperation between the slide block 21 and the shaping core 22. Comparing to the conventional angled core-pulling mechanism of mold, the angled core-pulling mechanism of mold 100 of the present invention does not need extra apparatus providing a driving force to realize the angled core-pulling process. Therefore, the angled core-pulling mechanism of mold 100 has a so simple structure that it has a smaller size to mold holes of a small plastic product and can be easily assembled.

What is claimed is:

1. An angled core-pulling mechanism of mold, comprising:
a core insert defining a shaping cavity, a slide hole at one side of the shaping cavity, and a receiving fillister opened in a front of the core insert and having a level bottom face, the slide hole extending downward and slanting forward, a top of the slide hole communicating with the shaping cavity and a bottom of the slide hole being connected with a top of the receiving fillister; and
a core-pulling body movably mounted to the core insert, including
a shaping core having a base block of which two opposite end surfaces oppositely protrude to form a track and a shaping portion, the base block being slantwise slidably disposed in the slide hole of the core insert, and
a slide block having a base body of which a rear end longitudinally defines a slide passage penetrating through a top surface and a rear surface, a bottom side of the slide passage slanting downward from a front to a rear thereof, the track of the shaping core being slidably disposed in the slide passage, wherein the slide block can longitudinally move along the bottom face of the receiving fillister to drive the shaping core to slide slantwise upward and downward along the slide hole so that the shaping portion of the shaping core can be inserted into or withdrawn out of the shaping cavity.

2. The angled core-pulling mechanism of mold as claimed in claim 1, wherein the slide passage of the slide block includes a slide slot and a slide channel connected with a bottom of the slide slot and having a greater width than the one of the slide slot, the track of the shaping core is of substantial T-shape with a restraining portion and a connecting plate connected between the base block and the restraining portion, the restraining portion is slidably disposed in the slide channel and the connecting plate is received in the slide slot.

3. The angled core-pulling mechanism of mold as claimed in claim 1, wherein an opening is opened in the front of the core insert and located substantially in alignment with the slide hole and the receiving fillister, a substantial middle of the opening extends reward to form the receiving fillister, a rear side of the opening connected with the bottom face of the receiving fillister is acted as a guiding slope slanting forward from a top to a bottom thereof, the guiding slope lies in the same plane with a lower face of the slide hole of the core insert, the slide block can move slantwise upward and downward along the guiding slope so as to drive the base block of the shaping core to be inserted into or withdrawn out of the slide hole of the core insert.

4. The angled core-pulling mechanism of mold as claimed in claim 1, wherein two opposite sides of the rear end of the base body of the slide block define a pair of gaps, a blocking wall is accordingly formed in a front of each of the gaps to abut against the front of the core insert when the rear end of the slide block is inserted into the receiving fillister.

5. The angled core-pulling mechanism of mold as claimed in claim 1, wherein a front of the base body defines a perforation penetrating through the top surface and a bottom surface thereof, and slanting forward from a top to a bottom thereof for receiving a guide pin which drives the slide block to longitudinally move along the bottom face of the receiving fillister.
